(19) United States
(12) Patent Application Publication
(10) Pub. No.: US 2005/0055273 A1
(43) Pub. Date: Mar. 10, 2005

(54) Immediate discounts in consumer transactions

(76) Inventors: James R.W. Phillips, Bellevue, WA (US); David J. Rye, Kent, WA (US)

Correspondence Address: BLACK LOWE & GRAHAM, PLLC, 701 FIFTH AVENUE, SUITE 4800, SEATTLE, WA, 98104, US

(21) Appl. No.: 10/666,866

(22) Filed: Sep. 19, 2003

Related U.S. Application Data
(60) Provisional application No. 60/500,589, filed on Sep. 5, 2003.

(51) Int. Cl. G06F 17/60

(52) U.S. Cl. 705/14

(57) ABSTRACT

A system and a method in a computer for effecting a discount on a purchase of a second item include receiving from a customer a selection of a first item being offered for sale. Under control of the computer, the system and a method offer a discount for the second item.

### PRIORITY CLAIM

This application claims priority to a provisional application entitled “Immediate Discounts in Consumer Transactions” having Ser. No. 60/500,589 and filed Sep. 5, 2003. This application incorporates that provisional application by this reference.

### FIELD OF THE INVENTION

This invention relates generally to consumer retail transactions and, more specifically, to Internet enablement of consumer transactions.

### BACKGROUND OF THE INVENTION

Internet commerce has rapidly displaced some portion of traditional commerce from “brick and mortar” stores. Convenience and a great ability to quickly comparison shop have been the common appeal of shopping merchants' websites on the Internet. A potential customer can easily locate merchandise from several merchants within minutes and, in a “head-to-head” comparison, select the most advantageous price and delivery terms.

As the Internet commerce has matured, merchants have found it advantageous to offer discount coupons on merchandise in order to skew favorably the straight “head-to-head” comparison. To date, the strategy has been to first secure a sale and then to offer a discount on a subsequent purchase from the same merchant. The strategy seeks to build a brand-affinity by encouraging second transactions from the same merchant.

In practice, however, customers tend not to follow through with the second purchases at a desirable rate. Despite the offered savings, the customers either forget or misplace the coupons evidencing the offered discounts. Coupons sent with merchandise are often discarded with packing materials. Merchants may fail to email the coupons in timely or useful intervals. In short, the coupons are not highly effective in attracting repeat business.

If, rather than supplying the coupon for a subsequent sale, a merchant were to offer a more immediate and automatic discount, it is likely that customers would be more likely to purchase a second item from the same merchant. Rather than to offer a discount on a later sale, a discount would be more effective in encouraging a sale of a second item in the same order.

There is, then, an unmet need in the art for an instant discount, the discount being applicable to reduce the price of a second item in the same order.

### SUMMARY OF THE INVENTION

A system and a method in a computer for effecting a discount on a purchase of a second item include receiving from a customer a selection of a first item being offered for sale. Under control of the computer, the system and a method offer a discount for the second item.

In accordance with still further preferred aspects of the invention, the method includes the adjusting the discount according to a magnitude of the first item price.

In accordance with still further preferred aspects of the invention, a customer selects a second item being offered for sale. One embodiment of the invention receives the selection designating a second item identity and supplies a second item price based upon the second item identity.

In accordance with yet other preferred aspects of the invention, the discount is adjusted according to a magnitude of the second item price.

In accordance with yet other preferred aspects of the invention, a buy request is received from a customer and an order is compiled in response to the buy request based upon the selection of the first and the second items.

In accordance with still another preferred aspect of the invention, the discount is automatically applied to the order.

In accordance with still further preferred aspects of the invention, the order is presented as compiled to the customer. A buy confirmation is received from the customer. To complete a purchase of the first and second items, the order is forwarded for fulfillment.

### BRIEF DESCRIPTION OF THE DRAWINGS

The preferred and alternative embodiments of the present invention are described in detail below with reference to the following drawings.

FIG. 1 is a flow chart for a process of discounting a second purchase;

FIG. 2 is a network diagram of a server for receiving and discounting purchase orders;

FIG. 3 is an exemplary screen shot description of a first item offered for sale;

FIG. 4 is an exemplary screen shot offer of a discount on a second item offered for sale;

FIG. 5 is an exemplary screen shot of a check out page reflecting a selection of the first item offered for sale;

FIG. 6 is an exemplary screen shot description of a second item offered for sale; and

FIG. 7 is an exemplary screen shot of a check out page reflecting a selection of the second item offered for sale as discounted.

### DETAILED DESCRIPTION OF THE PREFERRED EMBODIMENT

By way of overview, a system and a method in a computer for effecting a discount on a purchase of a second item include receiving from a customer a selection of a first item being offered for sale. Under control of the computer, the system and a method offer a discount for the second item.

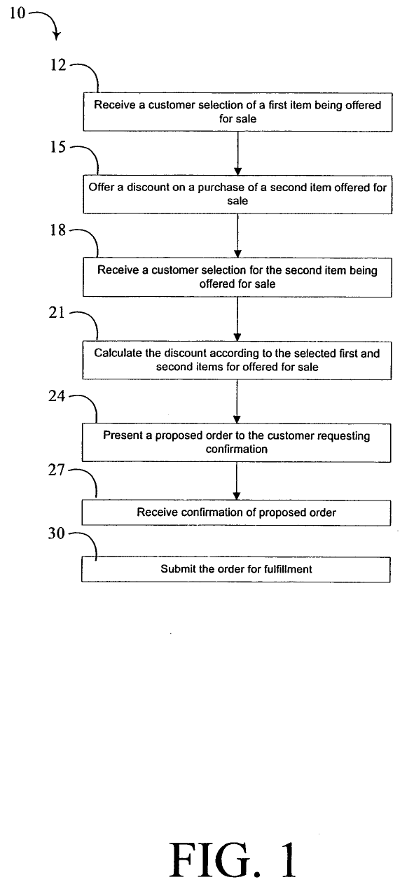

FIG. 1 is a flow chart for a process of discounting a second purchase. In one presently preferred embodiment, the method 10 begins with receiving a customer selection, at a block 12. The customer selection indicates interest in purchasing a good or service. Generally, receiving a customer selection, as at the block 12, will occur as the result of a customer browsing a website set up by a merchant to evoke sales of the described item. A customer may be directed to the website either from within the website by hyperlinks put in place by the merchant or as the result of a search for the particular item by any of several available search engines. Customers may use any of several other means to initiate a selection of a first item being offered for sale.

At a block 15, triggered by the customer's indicated interest in purchasing the selected item, a server will send a page describing a discount based upon the purchase of the selected item. At the block 15, the discount may be offered in such terms as meet the merchant's objectives. For instance, where the merchant is interested in selling an item in a line of items, the merchant might offer a large discount on a second purchase based upon the selection of the item. Alternatively, the merchant might offer a discount based upon the purchase price of the item as offered.

The merchant has other alternative strategies available as well. For instance, where the merchant wishes to encourage the sale of a second item with a higher purchase price, the discount might be a “sliding scale” discount. For instance, the discount might be offered as a step function based upon the price of the second item. Such a step function based upon the price of the second item might look like this:

| SPEND | SAVE |
|---|---|
| $19.99 - $29.99 | $5.00 |
| $30.00 - $69.99 | $10.00 |
| $70.00 - $119.99 | $22.00 |
| $120.00 - $169.99 | $40.00 |
| $170.00 - $249.99 | $55.00 |
| $250.00 - $299.99 | $70.00 |
| $300.00 or More | $100.00 |

Alternative discount strategies other than the table above can readily be implemented to achieve the sales goals of the merchant. For example, variable discounts can be offered depending on the quantity of additional items purchased. The ability to make the discount a function of both the purchase price of the first item and the purchase price of the second item allow the merchant a great deal of variability in the discount strategy.

At a block 18, receiving a customer selection for the second item offered for sale completes a discounted sale proposal. As the customer has selected both the first item offered for sale initiating the discount and the second item offered for sale exploiting the discount, a proposed order and price can be formulated. The discount can also be scaled beyond a second item, and could be applied to third and subsequent items as well, in much the same manner as that for the second item as described above.

At a block 21, the total amount for the proposed order is calculated including the discount on the second item offered for sale. Shipping, taxes, or other charges might be optionally included in the proposed order. The order can then be formulated to show the exact amount the customer will pay for the proposed order.

At a block 24, the proposed order is presented to the customer. One presently preferred embodiment is to formulate a specimen invoice generated as a page sent to the customer's web browser. The customer can review the specimen invoice to aid in making the purchase decision. The specimen invoice, in a presently preferred embodiment will include a button to indicate the customer's desire to complete the sales transaction.

At a block 27, the customer gives an indication of the desire to complete the sales transaction. For instance, a “buy” button is incorporated in the proposed order to indicate confirmation of the sale. Alternatively, a customer might simply be asked to provide payment information in order to consummate the sale. Alternate means are also possible for confirming the customer's desire to complete the sale on the terms set forth in the proposed order presented at the block 24.

At a block 30, when the customer has provided sufficient confirmation and has completed the payment and shipping terms, the order is submitted for fulfillment. Fulfillment occurs when an order has been accepted and the merchant makes arrangements for shipping conforming goods to the customer. Fulfillment in this process may include a variety of arrangements, including cash, credit, or COD payment, as well as mail or commercial courier shipping arrangements.

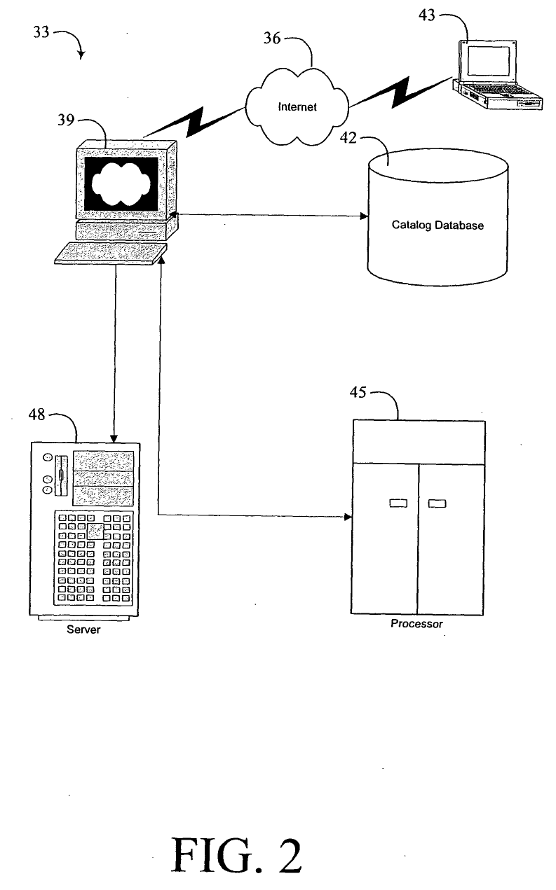

FIG. 2 is a network diagram of one presently preferred embodiment of a server system 33 for receiving and discounting purchase orders. An Internet server 39 is configured for receiving customer orders through a connection to the Internet 36. In a presently preferred embodiment, an active service page (not shown) resides on the Internet server 39 to facilitate the reception of the customer orders in a format that is sufficient to initiate the customer inquiry or order.

One presently preferred embodiment allows the customer to browse a catalog of items offered for sale. For each offering, identity information is provided to the customer by allowing the customer to interact with the Internet server 39. In turn, the Internet server 39 formulates the interactions into inquiries of a catalog database 42. Responses by the catalog database to the inquiries include identity information. The identity information is formulated into pages the Internet server 39 generates and sends to facilitate further interaction with the customer.

In one presently preferred embodiment, identity information might include the discount based upon any discount strategy the merchant wishes to effect. Thus, as the customer browses the catalog by interacting with the Internet server 39, the customer is provided with associated offers of discounts on a purchase of a second item offered for sale.

Once a customer indicates interest in purchasing a second item offered for sale, the Internet server 39 sends the identity information associated with the first and the second (and additional, if applicable) items offered for sale to a processor 45 for formulating a proposed order. The processor 45, in this presently preferred embodiment, sends requests to the customer through the Internet server 39 for such customer information as will complete the order. Information may include, optionally, shipping terms, payment terms, and address information. The processor 45 formulates the specimen invoice, generates the specimen invoice page, and presents the specimen invoice page to the customer. The order is complete when the customer has indicated a desire to consummate the sale. The Internet server 39 sends the compiled order from the processor 45 to the fulfillment server 48, to process the order. The fulfillment server 48 may, optionally, be the same fulfillment server the merchant uses for undiscounted sales.

It should be understood that each of the physical devices depicted in FIG. 2, including the Internet server 39, fulfillment server 48, processor 45, and database 42, could comprise a single physical computer “tower,” “server stack,” or other such device. As such, the separate functions could be combined into a single device, and, for that matter, one or more of the functions could be eliminated altogether. Alternatively, they may be organized as separate devices as shown. In addition, any number of client devices 43 such as individual remote computers owned or accessed by customers is in communication with the Internet in order to access the Internet server 39.

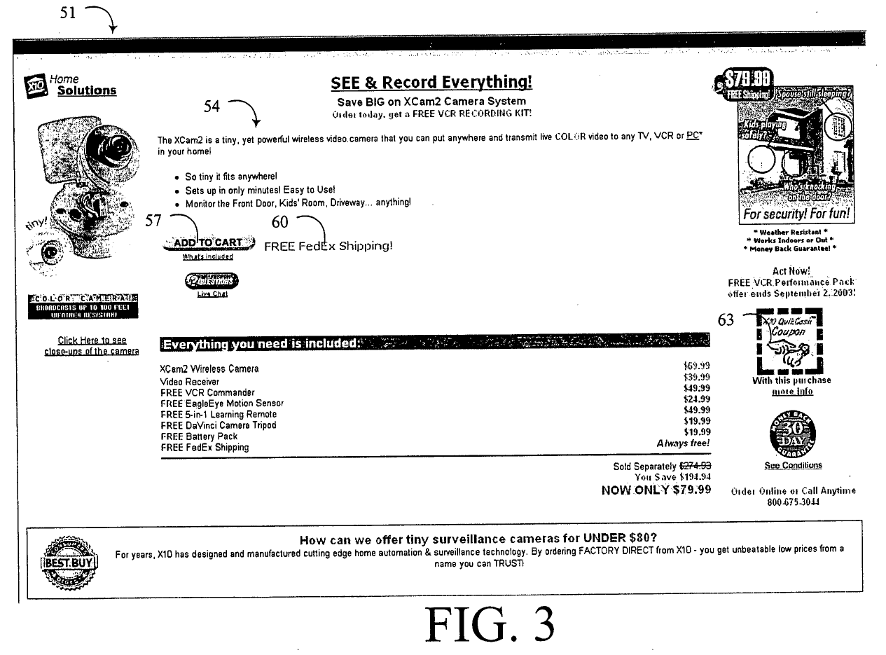

Referring to FIGS. 2 and 3, screen shots generated in the presently preferred embodiment further amplify the understanding of the system. As used here, “screen shot” refers to an HTML-based or other image that may be sent to the client 43 from the server and is readable by typical browser software for display at a client. FIG. 3 is an exemplary screen shot 51 of a first item offered for sale, in this case a wireless camera. The exemplary screen shot 51 includes a detailed description 54 of the first item offered for sale. Such information might be stored in and retrieved from the catalog database 42 to generate the page. Additionally, the customer is presented with an “add to cart” button 57 to confirm the customer's intent to purchase the first item offered for sale.

Icons for additional premiums 60 such as for free shipping are optionally included in the exemplary screen shot 51 to make the sale of the item offered for sale more attractive to the customer. Such additional premiums 60 may be optionally stored in the catalog database 42 in association with the first item offered for sale. Alternatively, global additional premiums, i.e. premiums offered with every sale regardless of the identity of the item offered for sale, might be stored on the Internet server 39 and placed in every exemplary screen shot 51.

A banner icon 63 indicative of the discount on the second item offered for sale is also included, just as the icon for additional premiums 60 are included, in order to make the first item offered for sale more attractive to the customer. Clicking on the banner icon 63 will generate (via a hyperlink to an appropriate page) a screen filled with additional information on the discount. The instant coupon can be presented using other textual or graphical images other than the icon shown.

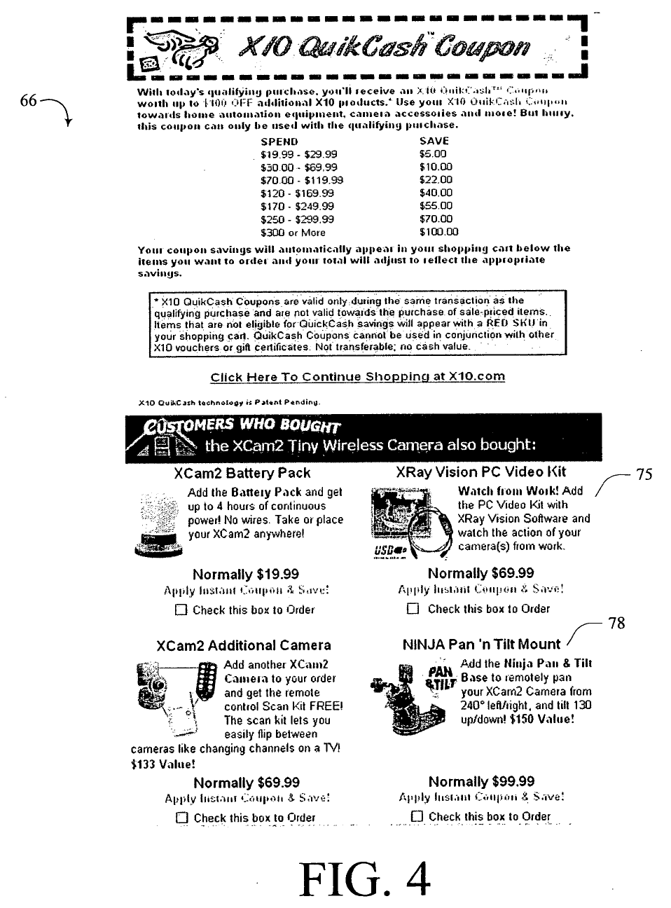

Referring to FIGS. 2, 3, and 4, to make the sale of the second item more likely, detailed information about the discount offered on the purchase of a second item offered for sale is presented to the customer. FIG. 4 shows an exemplary screen shot of a discount offer 66 on a second item offered for sale. In the presently preferred embodiment, the discount offer 66 is generated in response to the customer selection of either the “add to cart” button 57 or the banner icon 63 indicating the discount on the second item offered for sale. The discount offer 66 serves the purpose of explaining the eligibility for a discount.

Though the instant savings coupon can be employed with the purchase of any second or subsequent item, it can also be used to encourage the purchase of particular initial items. Thus, the instant coupon may only be applicable with the purchase of particular qualifying items, and not applicable with the purchase of certain other items. In such an embodiment, the server or processor is configured to evaluate whether any of the items in the shopping cart are “qualifying” items. If so, then the instant coupon is applicable. If not, the coupon will not be applied. By restricting the coupon to certain qualifying goods, it can encourage the purchase of the particular qualifying goods, the purchase of accessories best used with the qualifying goods, or both.

In order to define the offer of the discount, a sliding scale offer can be used. In such a preferred embodiment, a table of discounts 69 is included in the discount offer 66. As noted above, the discount strategy is not limited to sliding scale offers, but might be any discount strategy that a merchant employs to encourage sales. In the sliding scale embodiment, the table of discounts 69 might include discounts based upon a purchase price for the second item offered for sale. For instance, at a line 72, if the purchase price of the second item offered for sale is between $70 and $120, the discount applied to the purchase of the second item will be $22. A percentage discount, flat discount, or other formulation may alternatively be used.

To enhance the likelihood of the sale of a second item, or to encourage consumers to choose particular second or subsequent items for purchase, the discount offer 66 might optionally include a grouping 75 of possible second items offered for sale. To enhance the effectiveness of the offer, the grouping 75 would be formed based upon the ordering experience of the merchant or based on association with the first item selected. For instance, where several accessories for the first item are also offered, identities of the several accessories within the grouping 75 of possible second items offered for sale might be stored in the catalog database 42 in association with identity of the first item offered for sale. The grouping 75 might be dynamically updated based upon orders received by the merchant for a first item and a second item.

Remembering that an object of a discount strategy is to encourage the second sale, the merchant may tailor the grouping 75 of second items to exploit natural couplings of items. One such second item 78 offered for sale is a mount for the wireless camera shown in the exemplary screen shot 51 of a first item offered for sale. A description of each second item included in the grouping 75 associated with the wireless camera in the catalog database 42 is set forth making additional linking away from the discount offer 66 unnecessary. A coupling of a first and a second item offered for sale completes a system the customer might find useful thereby helping the customer to visualize the use of the first and second item and making the sale more likely.

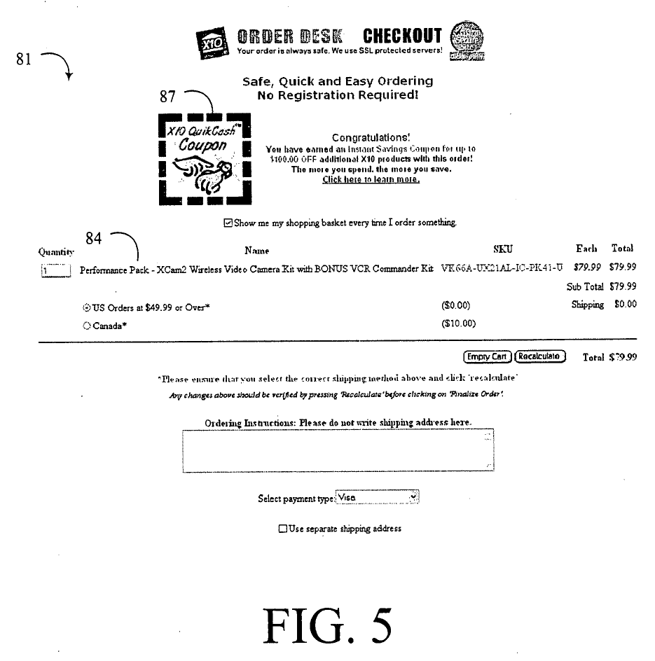

After adding an item to the shopping cart, the customer receives a confirmation of the selection of the first item offered for sale. FIG. 5 is a first specimen invoice 81 generated to inform the customer as to the proposed sale of the first item offered for sale. Along with discount offer 66, the first specimen invoice 81 may be generated in response to the clicking of the “add to cart” button 57. In a preferred embodiment, the discount offer 66 would overlay the first specimen invoice 81.

The first specimen invoice 81 includes a line item 84 indicating identity, price, and extended price information of the first item offered for sale. Additionally, a second icon indicative of the discount on the second item offered for sale 87 reminds the customer about the eligibility for a discount. Like the first icon indicative of the discount on the second item offered for sale 63, clicking will cause the discount offer 66 to be sent to the customer's browser.

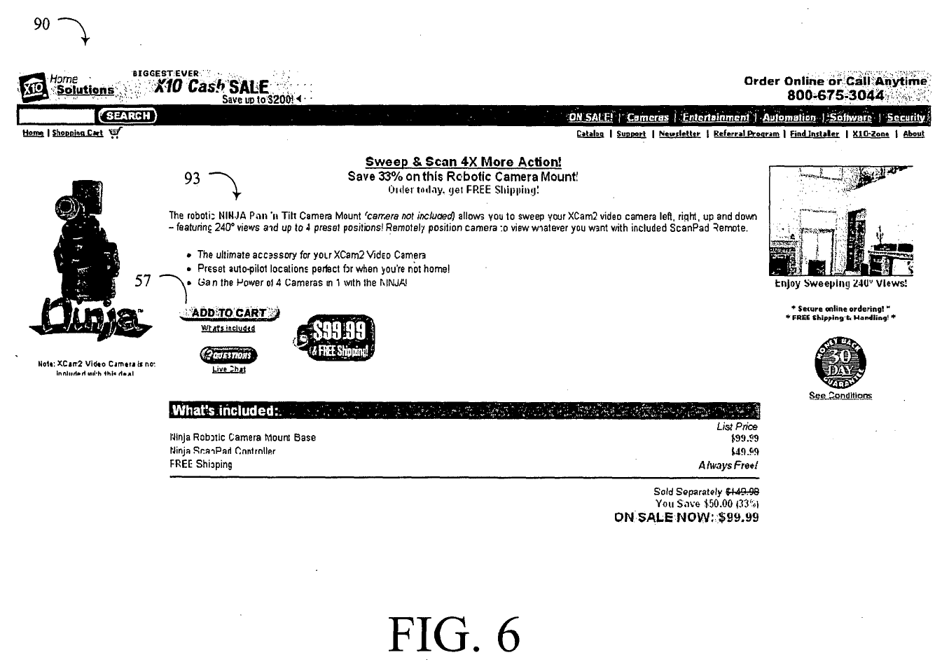

FIG. 6 is an exemplary screen shot of a second item offered for sale 90. Like the exemplary screen shot 51 of the first item offered for sale, the exemplary screen shot of a second item offered for sale 90 includes a detailed description 93 of the second item offered for sale. Also like the exemplary screen shot 51, the exemplary screen shot of a second item offered for sale 90 includes an “add to cart” button 57 allowing the customer to signal the customer's intent to consummate the purchase of the second item offered for sale.

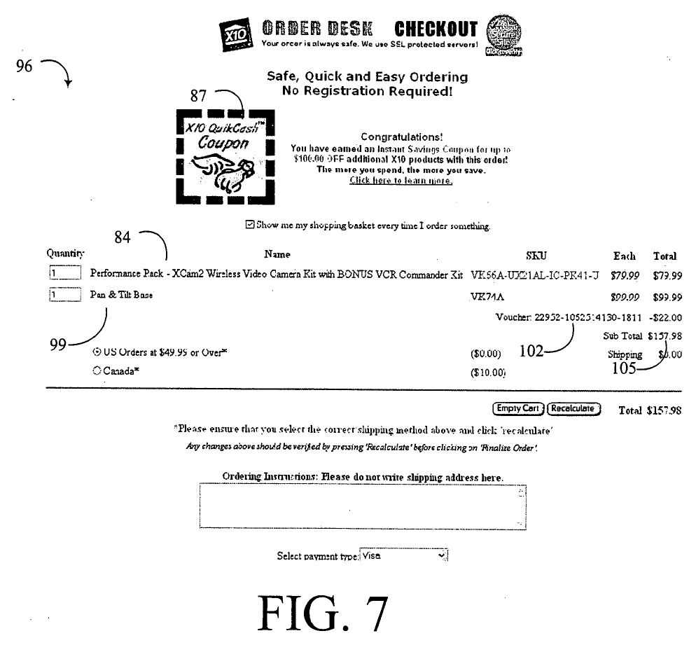

FIG. 7 is an exemplary screen shot of a second specimen invoice 96 reflecting a selection of the second item offered for sale as discounted. Triggered by any suitable indication of the customer's intent to consummate the sale, the second specimen invoice 96 includes the same line item 84 indicating identity, price, and extended price information of the first item offered for sale as well as a second line item 99 indicating identity, price, and extended price information of the second item offered for sale. A third line item 102 reflecting the application of the discount is automatically added to the second specimen invoice 96. A total price 105 is calculated and added to the second specimen invoice allowing the customer to confirm by clicking a confirmation “button” or other indicia that will produce a confirmation response to the server.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for offering a discount on a purchase comprising:
offering one or more items for sale via an Internet server accessible by a customer via a remote client;
receiving from the customer an indication to purchase a first item being offered for sale; and
offering a discount for the purchase of a second item.

2. The method of claim 1, the method further comprising:
adjusting the discount based upon a magnitude of the first item price.

3. The method of claim 1, the method further comprising:
receiving from a customer a selection of a second item being offered for sale, the selection designating a second item identity; and
supplying a second item price based upon the second item identity.

4. The method of claim 3, the method further comprising:
adjusting the discount based upon a magnitude of the second item price.

5. The method of claim 3, the method further comprising:
receiving from a customer a buy request; and
compiling an order in response to the buy request, based upon the selection of the first and the second items.

6. The method of claim 5, the method further comprising:
applying the discount to the order.

7. The method of claim 6, the method further comprising:
presenting the order as compiled to the customer; and
receiving a buy confirmation from the customer

8. The method of claim 5, the method further comprising:
submitting the order for fulfillment to complete a purchase of the first and second items in accordance with the order.

9. A server system for generating an order including effecting a discount on a purchase of a second item, the server system comprising:
a first component being configured to receive an order via an Internet to purchase a first item at a first item price; and
a second component being configured to offer a discount for a purchase of the second item.

10. The server system of claim 9, the server system further comprising:
a third component being configured to adjust the discount based upon a magnitude of the first item price.

11. The server system of claim 9, the first component being further configured to:
receive from a customer a selection of a second item being offered for sale, the order designating a second item identity; and
supply a second item price based upon the second item identity.

12. The server system of claim 11, the third component being further configured to:
adjust the discount based upon a magnitude of the second item price.

13. The server system of claim 11, the first component being further configured to:
receive from a customer a buy request; and
compile an order in response to the buy request, based upon the selection of the first and the second items.

14. The server system of claim 13, the third component being further configured to:
apply the discount to the order.

15. The server system of claim 14, the first component being further configured to:
present the order as compiled to the customer; and
receive a buy confirmation from the customer

16. The server system of claim 14, the server system being further including:
a fourth component configured to submit the order for fulfillment to complete a purchase of the first and second items in accordance with the order.

17. A computer-readable medium containing instructions for causing a computer system of a customer to discount the price for a purchase of a second item being offered for sale by a vendor, the instructions comprising:
means for receiving from the customer a request to purchase the first item being offered for sale;
means for calculating a discount on the purchase of the second item being offered for sale;
means for receiving from the customer a request to purchase the second item being offered for sale;
means for receiving from the customer a confirmation of the proposed order to purchase the first and the second items being offered for sale; and
means for submitting the order for fulfillment to complete a purchase of the first and second items in accordance with the order.

18. The computer-readable medium containing instructions of to a computer of claim 17, wherein the means for receiving from the customer a request to purchase the first item being offered for sale include means for displaying information relating to a first item being offered for sale to the customer.

19. The computer-readable medium containing instructions of to a computer of claim 17, wherein the means for calculating a discount on the purchase of the second item being offered for sale are dependent upon an identity of the first item being offered for sale to the customer.

20. The computer-readable medium containing instructions of to a computer of claim 19, wherein the means for calculating a discount on the purchase of the second item being offered for sale are dependent upon a first item price.

21. The computer-readable medium containing instructions of to a computer of claim 17, wherein the means for calculating a discount on the purchase of the second item being offered for sale are dependent upon an identity of the second item being offered for sale to the customer.

22. The computer-readable medium containing instructions of to a computer of claim 19, wherein the means for calculating a discount on the purchase of the second item being offered for sale are dependent upon a second item price.

23. The computer-readable medium containing instructions of to a computer of claim 17, wherein the means for receiving from the customer a request to purchase the second item being offered for sale include means for displaying information relating to a second item being offered for sale to the customer.

24. The computer-readable medium containing instructions of to a computer of claim 17, wherein the means for receiving from the customer a confirmation of the proposed order to purchase the first and the second items being offered for sale; include means for displaying the information including the purchase price of the first and the second items being offered for sale and the discount.
